(19) United States
(12) Patent Application Publication
(10) Pub. No.: US 2022/0358349 A1
(43) Pub. Date: Nov. 10, 2022

(54) DEEP LEARNING ACCELERATOR MODELS AND HARDWARE

(71) Applicant: Micron Technology, Inc., Boise, ID (US)

(72) Inventors: Poorna Kale, Folsom, CA (US); Saideep Tiku, Fort Collins, CO (US)

(21) Appl. No.: 17/314,970

(22) Filed: May 7, 2021

(51) Int. Cl. G06N 3/063; G06F 9/50; G06F 15/80

(52) U.S. Cl. CPC G06N 3/063; G06F 9/5027; G06F 15/80

(57) ABSTRACT

A first deep learning accelerator (DLA) model can be executed using a first subset of a plurality of DLA cores of a DLA chip. A second DLA model can be executed using a second subset of the plurality of DLA cores of the DLA chip. The first subset can include a first quantity of the plurality of DLA cores. The second subset can include a second quantity of the plurality of DLA cores that is different than the first quantity of the plurality of DLA cores.

### TECHNICAL FIELD

The present disclosure relates generally to memory, and more particularly to apparatuses and methods associated with deep learning accelerator (DLA) models using subsets of DLA cores of a DLA chip.

### BACKGROUND

Memory devices are typically provided as internal, semiconductor, integrated circuits in computers or other electronic devices. There are many different types of memory including volatile and non-volatile memory. Volatile memory can require power to maintain its data and includes random-access memory (RAM), dynamic random access memory (DRAM), and synchronous dynamic random access memory (SDRAM), among others. Non-volatile memory can provide persistent data by retaining stored data when not powered and can include NAND flash memory, NOR flash memory, read only memory (ROM), Electrically Erasable Programmable ROM (EEPROM), Erasable Programmable ROM (EPROM), and resistance variable memory such as phase change random access memory (PCRAM), resistive random access memory (RRAM), and magnetoresistive random access memory (MRAM), among others.

Memory is also utilized as volatile and non-volatile data storage for a wide range of electronic applications. including, but not limited to personal computers, portable memory sticks, digital cameras, cellular telephones, portable music players such as MP3 players, movie players, and other electronic devices. Memory cells can be arranged into arrays, with the arrays being used in memory devices.

### BRIEF DESCRIPTION OF THE DRAWINGS

FIG. 1 is a block diagram of an apparatus in the form of a computing system including a memory device in accordance with a number of embodiments of the present disclosure.

FIG. 2A is a block diagram of virtual DLA chips in accordance with a number of embodiments of the present disclosure.

FIG. 2B is a block diagram of virtual DLA chips in accordance with a number of embodiments of the present disclosure.

FIG. 3 is a block diagram representation of determining when to switch virtual DLA chips in accordance with a number of embodiments of the present disclosure.

FIG. 4 is a flow diagram of a method for executing DLA models using subsets of DLA cores of a DLA chip in accordance with a number of embodiments of the present disclosure.

FIG. 5 is a flow diagram of a method for executing DLA models using subsets of DLA cores of a DLA chip in accordance with a number of embodiments of the present disclosure.

FIG. 6 illustrates an example computer system within which a set of instructions, for causing the machine to perform various methodologies discussed herein, can be executed.

### DETAILED DESCRIPTION

The present disclosure includes apparatuses and methods related to executing deep learning accelerator (DLA) models using subsets of DLA cores of a DLA chip. Artificial intelligence (AI) can be employed on devices and/or systems that have a limited power supply. As used herein, artificial intelligence refers to the ability to improve a machine through “learning” such as by storing patterns and/or examples which can be utilized to take actions at a later time. Deep learning refers to a device's ability to learn from data provided as examples. Deep learning can be a subset of artificial intelligence. Artificial neural networks, among other types of networks, can be classified as deep learning.

Non-limiting examples of AI applications include deep-learning edge applications such as object detection, classification, tracking, and navigation. Deep-learning edge applications can be deployed on unmanned vehicles (e.g., drones) that are dependent on battery-based power supplies. How deep-learning edge applications are deployed on and/or utilized with such power-constrained devices and/or systems is contingent on efficient energy utilization of deep-learning edge applications. Deep-learning edge applications may be executed by DLAs. However, DLAs are not re-configurable or partitioned. During manufacturing, DLAs are produced meeting requirements of a workload, but the DLAs cannot be adapted to changes in the workload post-manufacturing. Some previous approaches to improving energy efficiency of DLAs may include using DLA application specific integrated circuits (ASICs).

Multiple DLA models (e.g., deep learning models) of the same type (e.g., MobileNet, ResNet, VGG19, etc.) may be executed to perform detection and/or classification for a given deep learning task. Each of the DLA models may be deployed on a respective DLA ASIC. The DLA ASICs may have different computational capabilities and/or processing requirements corresponding to computational capabilities and/or processing requirements of the DLA models. As used herein, “computational capability” refers to capability to perform computations whereas “processing requirements” refer to requirements to perform computations. To modify the computational capabilities and/or processing requirements of such a DLA package post-manufacturing would require an ability to modify the hardware of the DLA ASICs.

As used herein, “execution of a DLA model on data” refers to performance of calculations on the data using a DLA chip according to parameters of the DLA model. A DLA model can have parameters (be configured) such that execution of the DLA model yields results of at least a particular confidence value (e.g., accuracy value). As used herein, “accuracy of results yielded from execution of a DLA model” refers to a quantity of correct predictions made by the DLA model relative to a quantity of total predications made by the DLA model. Confidence in particular results yielded from execution of a DLA model can be referred to as, and expressed as, an accuracy value. Examples of parameters of a DLA model include, but are not limited to, a maximum quantity of multiply and accumulate circuits (MACs) of a DLA to be used during execution of the DLA model. Other non-limiting examples of parameters of a DLA model can be a maximum quantity of iterations of computations during execution of the DLA model and a maximum quantity of computations to be performed during execution of the DLA model. In at least one embodiment, execution of a DLA model implemented on a DLA can include utilization of at most a particular quantity (e.g., a subset) of MACs implemented on the DLA. Such parameters of a DLA model can limit the computational capability of the DLA model, which, in turn, can limit the accuracy of results yielded from execution of the DLA model. However, what may be lost in computational capability can be gained in reduced resource consumption.

A DLA model configured to yield high-accuracy results can utilize a greater quantity of MACs, perform a greater quantity of iterations of computations, and/or perform a greater quantity of computations during execution of the DLA model than a different DLA model configured to yield low-accuracy results. Execution of a DLA model configured to yield high-accuracy results can consume more resources than execution of a DLA model configured to yield low-accuracy results. For example, execution of a DLA model configured to yield high-accuracy results can have greater power requirements (greater power consumption) than execution of a DLA model configured to yield results of a lower accuracy.

In some previous approaches, DLA models configured to yield high-accuracy results may be executed in situations that do not require high-accuracy results. Thus, some previous approaches may expend more power executing a DLA model having high computational capability when executing a DLA model having low computational capability yields sufficiently accurate results. Executing a DLA model having high computational capability in such circumstances expends excess power relative to executing a DLA model having low computational capability. In low-power devices, such as Internet-of-Things (IoT) devices, reducing excess power expenditures is important.

Aspects of the present disclosure address the above and other deficiencies. For instance, execution of various DLA models can be assigned to subsets of DLA cores of a DLA chip. The quantity of DLA cores assigned to execute a DLA model can be based on the computational capability and/or processing requirements of the DLA model. Some embodiments of the present disclosure provide post-manufacturing flexibility not available in previous approaches. For example, the quantity of DLA cores of a DLA chip assigned to a subset and/or the quantity of subsets can be modified in response to modification of workloads and/or DLA models. Subsets of DLA cores can be configured on-demand (“on-the-fly”) at any time. An advantage of some embodiments described herein is an ability for on-demand workload aware compute deployment, utilization, and/or management. Computational capability of a DLA chip can be available on-demand and is scalable to satisfy changing requirements of deep-learning edge applications.

As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

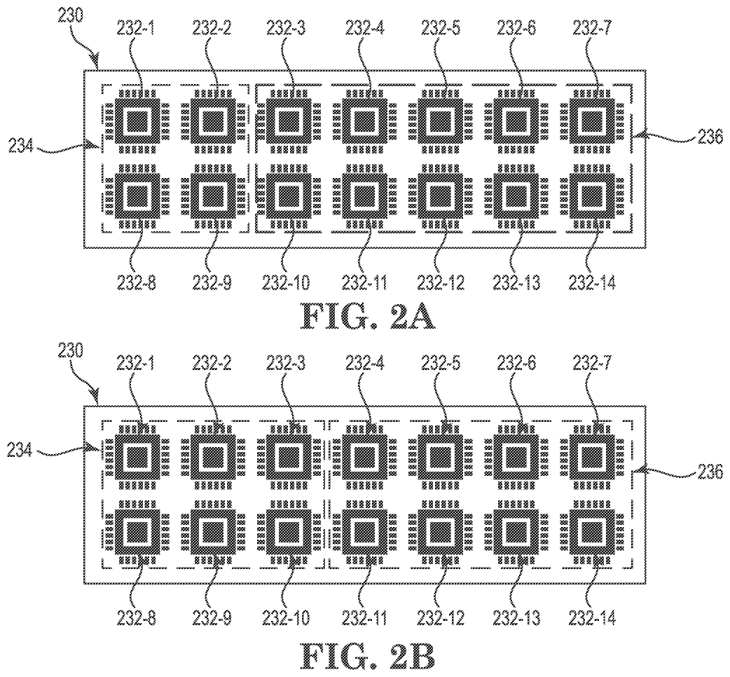

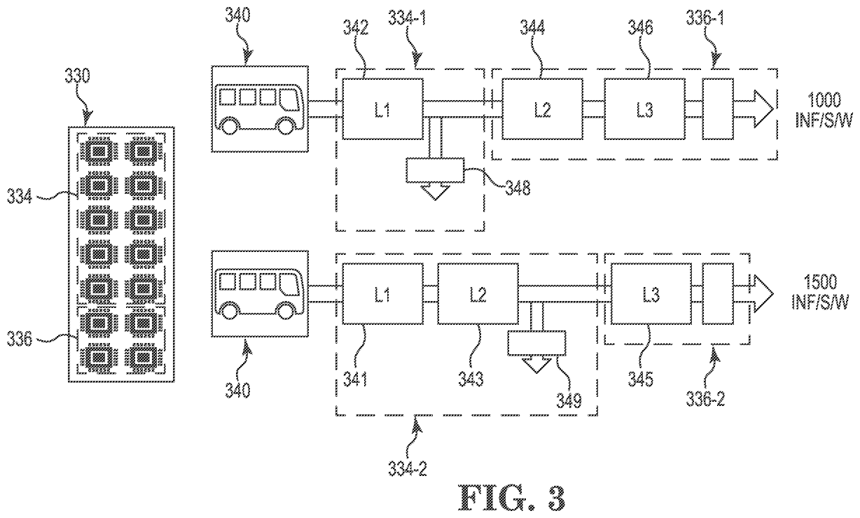

The figures herein follow a numbering convention in which the first digit or digits correspond to the drawing figure number and the remaining digits identify an element or component in the drawing. Similar elements or components between different figures may be identified by the use of similar digits. For example, 230 may reference element “30” in FIGS. 2A-2B, and a similar element may be referenced as 330 in FIG. 3. Analogous elements within a Figure may be referenced with a hyphen and extra numeral or letter. Such analogous elements may be generally referenced without the hyphen and extra numeral or letter. For example, elements 232-1, 232-2, 232-3, 232-4, 232-5, 232-6, 232-7, 232-8, 232-9, 232-10, 232-11, 232-12, 232-13, and 232-14 in FIGS. 2A-2B may be collectively referenced as 232. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention and should not be taken in a limiting sense.

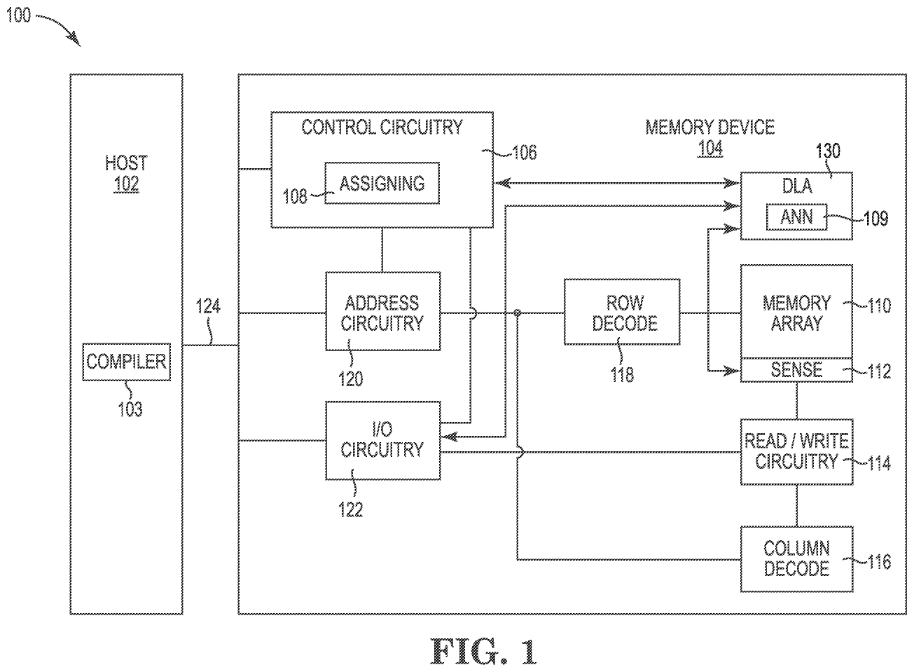

FIG. 1 is a block diagram of an apparatus in the form of a computing system 100 including a memory device in accordance with a number of embodiments of the present disclosure. The memory device 104 is coupled to a host 102 via an interface 124. As used herein, a host 102, a memory device 104, or a memory array 110, for example, might also be separately considered to be an “apparatus.” The interface 124 can pass control, address, data, and other signals between the memory device 104 and the host 102. The interface 124 can include a command bus (e.g., coupled to the control circuitry 106), an address bus (e.g., coupled to the address circuitry 120), and a data bus (e.g., coupled to the input/output (I/O) circuitry 122). In some embodiments, the command bus and the address bus can be comprised of a common command/address bus. In some embodiments, the command bus, the address bus, and the data bus can be part of a common bus. The command bus can pass signals between the host 102 and the control circuitry 106 such as clock signals for timing, reset signals, chip selects, parity information, alerts, etc. The address bus can pass signals between the host 102 and the address circuitry 120 such as logical addresses of memory banks in the memory array 110 for memory operations. The interface 124 can be a physical interface employing a suitable protocol. Such a protocol may be custom or proprietary, or the interface 124 may employ a standardized protocol, such as Peripheral Component Interconnect Express (PCIe), Gen-Z interconnect, cache coherent interconnect for accelerators (CCIX), etc. In some cases, the control circuitry 106 is a register clock driver (RCD), such as RCD employed on an RDIMM or LRDIMM.

The memory device 104 and host 102 can be a satellite, a communications tower, a personal laptop computer, a desktop computer, a digital camera, a mobile telephone, a memory card reader, an IoT enabled device, an automobile, among various other types of systems. For clarity, the system 100 has been simplified to focus on features with particular relevance to the present disclosure. The host 102 can include a number of processing resources (e.g., one or more processors, microprocessors, or some other type of controlling circuitry) capable of accessing the memory device 104.

The memory device 104 can provide main memory for the host 102 or can be used as additional memory or storage for the host 102. By way of example, the memory device 104 can be a dual in-line memory module (DIMM) including memory arrays 110 operated as double data rate (DDR) DRAM, such as DDR5, a graphics DDR DRAM, such as GDDR6, or another type of memory system. Embodiments are not limited to a particular type of memory device 104. Other examples of memory arrays 110 include RAM, ROM, SDRAM, LPDRAM, PCRAM, RRAM, flash memory, and three-dimensional cross-point, among others. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased.

The control circuitry 106 can decode signals provided by the host 102. The control circuitry 106 can also be referred to as a command input and control circuit and can represent the functionality of different discrete ASICs or portions of different ASICs depending on the implementation. The signals can be commands provided by the host 102. These signals can include chip enable signals, write enable signals, and address latch signals, among others, that are used to control operations performed on the memory array 110. Such operations can include data read operations, data write operations, data erase operations, data move operations, etc. The control circuitry 106 can comprise a state machine, a sequencer, and/or some other type of control circuitry, which may be implemented in the form of hardware, firmware, or software, or any combination of the three.

Data can be provided to and/or from the memory array 110 via data lines coupling the memory array 110 to input/output (I/O) circuitry 122 via read/write circuitry 114. The I/O circuitry 122 can be used for bi-directional data communication with the host 102 over an interface. The read/write circuitry 114 is used to write data to the memory array 110 or read data from the memory array 110. As an example, the read/write circuitry 114 can comprise various drivers, latch circuitry, etc. In some embodiments, the data path can bypass the control circuitry 106.

The memory device 104 includes address circuitry 120 to latch address signals provided over an interface. Address signals are received and decoded by a row decoder 118 and a column decoder 116 to access the memory array 110. Data can be read from memory array 110 by sensing voltage and/or current changes on the sense lines using sensing circuitry 112. The sensing circuitry 112 can be coupled to the memory array 110. The sensing circuitry 112 can comprise, for example, sense amplifiers that can read and latch a page (e.g., row) of data from the memory array 110. Sensing (e.g., reading) a bit stored in a memory cell can involve sensing a relatively small voltage difference on a pair of sense lines, which may be referred to as digit lines or data lines.

The memory array 110 can comprise memory cells arranged in rows coupled by access lines (which may be referred to herein as word lines or select lines) and columns coupled by sense lines (which may be referred to herein as digit lines or data lines). Although the memory array 110 is shown as a single memory array, the memory array 110 can represent a plurality of memory arrays arraigned in banks of the memory device 104. The memory array 110 can include a number of memory cells, such as volatile memory cells (e.g., DRAM memory cells, among other types of volatile memory cells) and/or non-volatile memory cells (e.g., RRAM memory cells, among other types of non-volatile memory cells).

The memory device 104 can include a DLA 130 (e.g., a DLA ASIC). Hereinafter, the DLA 130 can be referred to as a physical DLA chip. The DLA 130 can be implemented on or near an edge of the memory device 104. For example, as illustrated by FIG. 1, the DLA 130 can be implemented external to the memory array 110. The DLA 130 can be on a data path (e.g., an output path) between the memory array 110 to the I/O circuitry 122.

The DLA 130 can be coupled to the control circuitry 106. The control circuitry 106 can control the DLA 130. For example, the control circuitry 106 can provide signaling to the row decoder 118 and the column decoder 116 to cause the transferring of data from the memory array 110 to the DLA 130 to provide an input to the DLA 130. The control circuitry 106 can cause the output of the DLA 130 to be provided to the I/O circuitry 122 and/or be stored back to the memory array 110.

The DLA 130 can be controlled, by the control circuitry 106, for example, to execute an artificial neural network (ANN) 109. A DLA model is a non-limiting example of an ANN. The ANN 109 can include hardware and/or firmware to implement a DLA model for performing operations on data. In some embodiments, the memory device 104 can be configured to store an ANN (e.g., the ANN 109) and the DLA 130 can be used to supplement operation of the ANN for various functions. For example, the DLA 130 and ANN 109 can be used to identify an object in an image and/or changes in images. Data indicative of an image can be input to the DLA 130.

In some embodiments, a compiler 103 can be hosted by the host 102. As used herein, “compiler” refers to hardware and/or software that compiles instructions from a source device to cause an action at a destination device. For example, the compiler 103 can compile instructions from the host 102 to cause the DLA 130 to execute one or more DLA models in accordance with the instructions. As used herein, a “compiler being configured to X” and “compiler being used to X” refers to the compiler compiling instructions to cause X.

As described herein, and particularly in association with FIG. 3, the compiler 103 can be used to determine when to switch from executing a DLA model using a subset of DLA cores of the DLA 130 to a different DLA model using a different subset of DLA cores of the DLA 130. The compiler 103 can include hardware, software, and/or firmware. For example, the compiler 103 can include hardware separate from a processor (not shown) of the host 102. In some embodiments, the compiler 103 can include computer-executable instructions that can be executed by a processor to compile the instructions.

The compiler 103 can be configured to assign a number of DLA cores of the DLA 130 to a subset of DLA cores and cause the number of DLA cores to execute a DLA model having a computational capability that is less than a cumulative computational capability of the plurality of DLA cores. The compiler 103 can assign the number of DLA cores based on a size of a computational layer of the DLA model. The compiler 103 can be configured to assign a different number of DLA cores of the physical DLA chip to a different subset of DLA cores and cause the different number of DLA cores of the different virtual DLA chip to execute a different DLA model. The compiler 103 can be configured to assign the number of DLA cores based on a size of a computational layer of the DLA model and assign the different number of DLA cores based on a size of a computational layer of the different DLA model. The size of the computational layer of the DLA model can be different than the size of the computational layer of the different DLA model. The compiler 103 can be configured to assign the number of DLA cores based on a computational capability of the DLA model and assign the different number of DLA cores based on a computational capability of the different DLA model. The computational capability of the DLA model can be different than the computational capability of the different DLA model. The compiler 103 can be configured to assign the number of DLA cores based on a user-defined quantity of DLA cores and/or a user-defined subset of the plurality of DLA cores of the DLA 130.

The complied instructions generated by the compiler 103 can be provided to the control circuitry 106 to cause the control circuitry 106 to execute the compiled instructions. Once the compiled instructions are stored in the memory array 110, the host 102 can provide commands to the memory device 104 to execute the compiled instructions utilizing the DLA 130. The compiled instructions can be executed by the DLA 130 to execute the ANN 109. The control circuitry 106 can cause the compiled instructions to be provided to the DLA 130. The control circuitry 106 can cause the DLA 130 to execute the compiled instructions. The control circuitry 106 can cause the output of the DLA 130 to be stored back to the memory array 110, to be returned to the host 102, and/or to be used to perform additional computations in the memory device 104.

The control circuitry 106 can also include assigning circuitry 108. In some embodiments, the assigning circuitry 108 can comprise an ASIC configured to assign DLA cores to one or more subsets of DLA cores as described herein. In some embodiments, the assigning circuitry 108 can represent functionality of the control circuitry 106 that is not embodied in separate discrete circuitry. The control circuitry 106 and/or the assigning circuitry 108 can be configured to assign execution of a DLA model to one or more DLA cores of a DLA chip (represented by the memory array 110). The control circuitry 106 and/or the assigning circuitry 108 can be configured to assign execution of a first DLA model to a first subset of DLA cores and execution of a second DLA model to a second subset of DLA cores. The control circuitry 106 and/or the assigning circuitry 108 can be configured to assign a quantity of DLA cores to a subset based on processing requirements of a DLA model to be executed by the executed by the subset of DLA cores. The control circuitry 106 and/or the assigning circuitry 108 can be configured to receive user-defined subsets of DLA cores and/or user-defined quantities of DLA cores.

FIG. 2A is a block diagram of virtual DLA chips 234 and 236 in accordance with a number of embodiments of the present disclosure. FIG. 2A illustrates a physical DLA chip 230 including 14 DLA cores 232-1, 232-2, 232-3, 232-4, 232-5, 232-6, 232-7, 232-8, 232-9, 232-10, 232-11, 232-12, 232-13, and 232-14. Although the physical DLA chip is illustrated with 14 DLA cores, embodiments of the present disclosure are not so limited. For example, the physical DLA chip 230 can include fewer than or greater than 14 DLA cores.

FIG. 2A illustrates the DLA cores 232 assigned to two subsets, virtual DLA chip 234 and virtual DLA chip 236. As used herein, a “virtual DLA chip” refers to a subset of DLA cores of a physical DLA chip that operates in a manner similar to a DLA ASIC but without any physical delineation. The physical DLA chip 230 can be analogous to the DLA 130 described in association with FIG. 1.

The virtual DLA chips 234 and 236 can be configured to execute a DLA model having a computational capability that is less than a cumulative computational capability of the plurality of DLA cores 232. The virtual DLA chip 234 includes 4 of the 14 DLA cores 232 of the physical DLA chip 230, the DLA cores 232-1, 232-2, 232-8, and 232-9. The virtual DLA chip 236 includes 8 of the 14 DLA cores 232 of the physical DLA chip 230, the DLA cores 232-3, 232-4, 232-5, 232-6, 232-7, 232-10, 232-11, 232-12, 232-13, and 232-14. In the example of FIG. 2A, all 14 DLA cores 232 are assigned to either the virtual DLA chip 234 or the virtual DLA chip 236. However, embodiments are not limited to all DLA cores of a physical DLA chip being assigned to (e.g., members of) a virtual DLA chip. For instance, fewer than the 14 DLA cores 232 of the physical DLA chip 230 can be assigned to one or more virtual DLA chips. Embodiments are not limited to these specific examples. A quantity of DLA cores 232 of the virtual DLA chip 234 or 236 can be based on a size of a computational layer of a DLA model to be executed by the virtual DLA chip 234 or 236, respectively. The virtual DLA chip 234 can include an array of MACs of a size corresponding to processing requirements of the first DLA model. The virtual DLA chip 236 can include an array of MACs of a size corresponding to processing requirements of the second DLA model. The virtual DLA chip 236 can include a larger array of MACs than the DLA chip 234. For example, the virtual DLA chip 234 can include a 256×256 array of MACs and the virtual DLA chip 236 can include a 512×512 array of MACs.

The virtual DLA chip 234 includes fewer of the DLA cores 232 than the virtual DLA chip 236. Thus, the virtual DLA chip 234 can be referred to as a “little” virtual DLA chip and the virtual DLA chip 236 can referred to as a “big” virtual DLA chip. The virtual DLA chip 234 can execute a DLA model having lower computational capability and/or processing requirements whereas the virtual DLA chip 236 can execute a DLA model having higher computational capability and/or processing requirements. In some embodiments, the virtual DLA chips 234 and 236 can execute respective DLA models concurrently. For example, the virtual DLA chip 234 can execute a DLA model concurrently with execution of another DLA model, by the virtual DLA chip 236, having higher computational capability and/or processing requirements. In some embodiments, multiple virtual DLA chips can execute the same DLA model and/or DLA models having similar computational capabilities and/or processing requirements concurrently.

In some embodiments, the virtual DLA chip 234 can execute computational layers of a DLA model until the confidence of the results falls below a threshold. In response to the confidence of the results falling below the threshold, another DLA model having higher computational capability and/or processing requirements can be executed by the virtual DLA chip 236 using the results from the virtual DLA chip 234 as input. Such embodiments provide energy savings by not executing a DLA model using the “big” virtual DLA chip 236, which consumes more energy than the “little” virtual DLA chip 234, until the “big” virtual DLA chip 236 is needed.

FIG. 2B is a block diagram of virtual DLA chips 234 and 236 in accordance with a number of embodiments of the present disclosure. In some embodiments, the quantity of virtual DLA chips and/or respective quantities of member DLA cores of virtual DLA chips can be increased and/or decreased to satisfy changes to workloads of a physical DLA chip. In comparison to FIG. 2A, the virtual DLA chips 234 and 236, as illustrated by FIG. 2B, include different quantities of the DLA cores 232. As illustrated by FIG. 2B, the virtual DLA chip 234 includes 6 of the 14 DLA cores 232 of the physical DLA chip 230 and the virtual DLA chip 236 includes 8 of the 14 DLA cores 232 of the physical DLA chip 230. In some embodiments, a sum of the quantities of DLA cores of the virtual DLA chips 234 and 236 can be less than all the plurality of DLA cores 232 of the physical DLA chip 230.

In comparison to FIG. 2A, the virtual DLA chips 234 and 236, as illustrated by FIG. 2B, include different DLA cores of the physical DLA chip 230. As illustrated by FIG. 2A, the virtual DLA chip 234 includes the DLA cores 232-1, 232-2, 232-8, and 232-9 and the virtual DLA chip 236 includes the DLA cores 232-3, 232-4, 232-5, 232-6, 232-7, 232-10, 232-11, 232-12, 232-13, and 232-14. 232-1, 232-2, 232-3, 232-8, 232-9, and 232-10. In contrast, as illustrated by FIG. 2B, the virtual DLA chip 234 includes the DLA cores 232-1, 232-2, 232-3, 232-8, 232-9, and 232-10 and the virtual DLA chip 236 includes the DLA cores 232-4, 232-5, 232-6, 232-7, 232-11, 232-12, 232-13, and 232-14.

The quantity of member DLA cores of a virtual DLA chip can be modified in response to changes to a DLA model to be executed by the virtual DLA chip. Relative to FIG. 2A, the quantity of member DLA cores of the virtual DLA chip 234 is increased by two and the quantity of member DLA cores of the virtual DLA chip 236 is decreased by two. Such changes can be indicative of the virtual DLA chip 234 executing a different DLA model having increased computational capability and/or processing requirements and/or the virtual DLA chip 236 executing a different DLA model having decreased computational capability and/or processing requirements.

In some embodiments, the quantity of member DLA cores of a virtual DLA chip can be user-defined. A user can provide input specifying respective quantities of DLA cores to assign to one or more virtual DLA chips. For example, a user can provide input that the virtual DLA chip 234 is to include 4 of the DLA cores 232 as described in association with FIG. 2A. At compile time, the user input can be used to assign one or more of the DLA cores 232 to a virtual DLA chip (e.g., the virtual DLA chip 234 or 236). In some embodiments, particular DLA cores to be members of a virtual DLA chip can be user-defined. A user can provide input specifying which DLA cores to assign to one or more virtual DLA chips. For example, a user can provide input specifying that the virtual DLA circuit 234 is to include the DLA cores 232-1, 232-2, 232-3, 232-8, 232-9, and 232-10 as described in association with FIG. 2B.

Although FIGS. 2A-2B illustrate the virtual DLA chips 234 and 236 including only adjacent DLA cores of the physical DLA chip 230, embodiments are not so limited. In some embodiments, virtual DLA chips can include non-adjacent DLA cores of the physical DLA chip 230. For example, the virtual DLA chip 234 can include the DLA cores 232-1, 232-2, 232-7, and 232-14.

FIG. 3 is a block diagram representation of determining a switch from a virtual DLA chip 334 to another virtual DLA chip 336 in accordance with a number of embodiments of the present disclosure. As described in association with FIG. 2A, in some embodiments, a first DLA model can be executed by a first virtual DLA chip (e.g., the virtual DLA chip 234). Based on confidence (e.g., accuracy) of results from execution of the first DLA model after a compile time, the physical DLA chip 330 can switch from execution of the first DLA model using the first virtual DLA chip to execution of a second DLA model using a second virtual DLA chip (e.g., the virtual DLA chip 236).

In some embodiments, if and when to switch execution of DLA models and corresponding virtual DLA chips can be determined at compile time based on data representative of data on which execution of the DLA models is anticipated (hereinafter referred to as representative data). Instead of determining if and when to switch execution of DLA models and corresponding virtual DLA chips reactively based on confidence of results from execution of the DLA models on data received after compile time, in some embodiments if and when to switch execution of DLA models and corresponding virtual DLA chips can be determined proactively based on execution of DLA models on representative data. Results from execution of the DLA models on the representative data can evaluated (e.g., confidence of results can be evaluated) to determine if and when to switch execution of DLA models and corresponding virtual DLA chips. A quantity of computational layers of a first DLA model to be executed prior to switching to execution of a second DLA model can be determined.

Subsequent to executing the first and second DLA models on the representative data, the determined quantity of computational layers of the first DLA model can be executed on data received by the physical DLA chip 330 before switching to execution of the second DLA model, regardless of confidence of results from execution of the first DLA model and/or the second DLA model on the data. Executing DLA models on representative data at compile time to determine if and when to exit early from execution of the first DLA model and/or the second DLA model can improve execution of the first DLA model and/or the second DLA model on data subsequent to compile time by eliminating evaluation of results from execution of the first DLA model and/or the second DLA model on data subsequent to compile time. Eliminating evaluation of results subsequent to compile time can decrease the amount of time between executions of computational layers of a DLA model and/or execution of a computational layer of a DLA model and execution of a computational layer of different DLA model.

FIG. 3 illustrates a physical DLA chip 330 including 10 DLA cores. Although the physical DLA chip 330 is illustrated with fewer DLA cores than the physical DLA chip 230 described in association with FIGS. 2A-2B, the physical DLA chip 330, and DLA cores thereof, can be analogous to the physical DLA chip 230 and the DLA cores 232, respectively. Four of the DLA cores of the physical DLA chip 330 are members of a virtual DLA chip 334. Six of the DLA cores of the physical DLA chip 330 are members of another virtual DLA chip 336. The dashed boxes 334-1 and 334-2 encompass operations performed by the virtual DLA chip 334 and 336-1 and 336-2 encompass operations performed by the virtual DLA chip 336. The upper portion of FIG. 3 illustrates a sequence of execution of the first DLA model and the second DLA model on the representative data 340 (hereinafter referred to as “the upper sequence”). In FIG. 3, “334-1” and “336-1” refer to operations performed by the virtual DLA chips 344 and 336, respectively, according to the upper sequence. The lower portion of FIG. 3 illustrates a different sequence of execution of the first DLA model and the second DLA model on the representative data 340 (hereinafter referred to as “the lower sequence”). In FIG. 3, “334-2” and “336-2” refers to operations performed by the virtual DLA chips 344 and 336, respectively according to the lower sequence.

The representative data 340 can be chosen based on expected data on which DLA models will be executed. In the example of FIG. 3, the physical DLA chip 330 is a component of an autonomous vehicle (not shown). Thus, the representative data 340 includes an image of a bus. In some embodiments, multiple sequences of execution of DLA models on representative data can be evaluated to determine when to switch from execution of a DLA model to different DLA model to yield final results having at least a threshold confidence (e.g., a threshold accuracy). In some embodiments, multiple sequences of execution of DLA models on representative data can be evaluated to determine which of the sequences yields final results having the highest confidence (e.g., the highest accuracy). A non-limiting example of a metric of accuracy is correct inferences per second per watt (inf/s/w).

At 342 of the upper sequence, computational layer L1 of the first DLA model is executed on the representative data 340 using the virtual DLA chip 334. At 348, an early exit from execution of the first DLA model occurs and the results from execution of the computational layer L1 are input to the second virtual DLA chip 336. At 344 and 346, respectively, two computational layers of the second DLA model, computational layer L1 and computational layer L2, are executed using the second virtual DLA chip 336. The upper sequence yields results having 1,000 inf/s/w.

At 341 and 343 of the lower sequence, respectively, computational layer L1 and computational layer L2 of the first DLA model are executed on the representative data 340 using the virtual DLA chip 334. At 349, an early exit from execution of the first DLA model occurs and the results from execution of the computational layers L1 and L2 of the first DLA model are input to the second virtual DLA chip 336. At 345, a computational layer of the second DLA model, computational layer L1, is executed using the second virtual DLA chip 336. The lower sequence yields results having 1,500 inf/s/w. Thus, the lower sequence yields more accurate results than the upper sequence. The lower sequence can be selected for execution of the first and second DLA models on data received by the physical DLA chip 330 after compile time based on the higher accuracy of that sequence (1,500 inf/s/w versus 1,000 inf/s/w) or the accuracy being at least a threshold accuracy (e.g., at least 1,250 inf/s/w).

In some embodiments, executing DLA models on representative data can be used to determine if the quantity of member DLA cores of virtual DLA chips (e.g., the virtual DLA chips 334 and 336) needs to be changed to improve the accuracy of results. For example, instead of or in addition to changing which computational layers of DLA models to execute to improve the accuracy of the results, additional DLA cores can be assigned to one or more of the virtual DLA chips 334 and 336. In some embodiments, the quantity of member DLA cores of one or more of the virtual DLA chips 334 and 336 can be decreased if the accuracy of results from the representative data 340 is more than needed to reduce energy consumption by (improve energy efficiency of) the physical DLA chip 330.

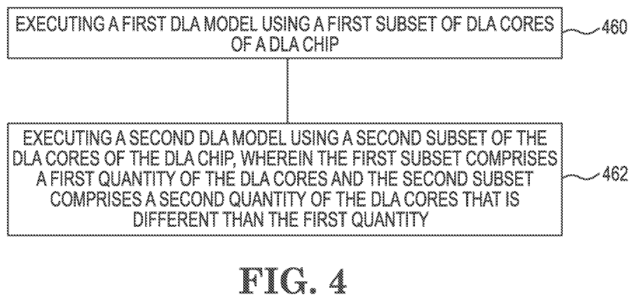

FIG. 4 is a flow diagram of a method for executing DLA models using subsets of DLA cores of a DLA chip in accordance with a number of embodiments of the present disclosure. The method can be performed by processing logic that can include hardware (e.g., a processing device, circuitry, dedicated logic, programmable logic, microcode, hardware of a device, integrated circuit, etc.), software (e.g., instructions run or executed on a processing device), or a combination thereof. In some embodiments, the method is performed by the control circuitry (e.g., the control circuitry 106 described in association with FIG. 1). Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At block 460, the method can include executing a first DLA model using a first subset of a plurality of DLA cores of a DLA chip. The first subset can include a first quantity of the plurality of DLA cores. The first quantity of the plurality of DLA cores can be assigned to the first subset of the DLA cores based on a first computational capability of the first DLA model.

At block 462, the method can include executing a second DLA model using a second subset of the plurality of DLA cores of the DLA chip. The second subset can include a second quantity of the plurality of DLA cores that is different than the first quantity of the plurality of DLA cores. The second quantity of the plurality of DLA cores can be assigned to the second subset of the DLA cores based on a second computational capability of the second DLA model. The second computational capability can be greater than the first computational capability. A greater quantity of the plurality of DLA cores can be assigned to the second subset of the plurality of DLA cores than the first quantity of the plurality of DLA cores assigned to the first subset of the plurality of DLA cores. The second quantity of the plurality of DLA cores can be assigned to the second subset of the DLA cores based on a second computational capability of the second DLA model. The second computational capability can be less than the first computational capability. A lesser quantity of the plurality of DLA cores can be assigned to the second subset of the plurality of DLA cores than the first quantity of the plurality of DLA cores assigned to the first subset of the plurality of DLA cores.

Although not specifically illustrated, the method can include executing the first DLA model using the first subset of the plurality of DLA cores and the second DLA model using the second subset of the plurality of DLA cores at least partially concurrently.

Although not specifically illustrated, the method can include executing a third DLA model using a third subset of the plurality of DLA cores of the DLA chip. The third subset can include a third quantity of the plurality of DLA cores that is different than the first and third quantities of the plurality of DLA cores. The third quantity of the plurality of DLA cores can be to the third subset of the DLA cores based on a third computational capability of the third DLA model. The third computational capability can be different than the first and second computational capabilities.

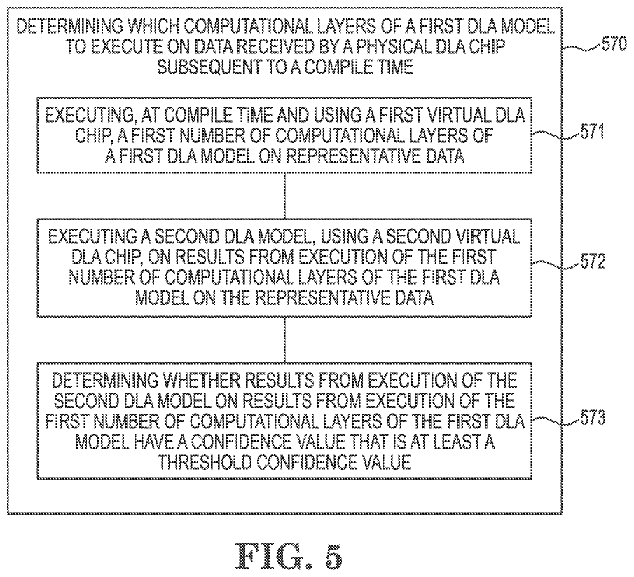

FIG. 5 is a flow diagram of a method for executing DLA models using subsets of DLA cores of a DLA chip in accordance with a number of embodiments of the present disclosure. The method can be performed by processing logic that can include hardware (e.g., a processing device, circuitry, dedicated logic, programmable logic, microcode, hardware of a device, integrated circuit, etc.), software (e.g., instructions run or executed on a processing device), or a combination thereof. In some embodiments, the method is performed by the control circuitry (e.g., the control circuitry 106 described in association with FIG. 1). Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At block 570, the method can include determining which computational layers of a first DLA model to execute on data received by a physical DLA chip subsequent to a compile time. Determining which computational layers of the first DLA model to execute can include, at block 571, executing, at compile time and using a first virtual DLA chip, a first number of computational layers of a first DLA model on representative data and, at block 572, executing a second DLA model, using a second virtual DLA chip, on results from execution of the first number of computational layers of the first DLA model on the representative data. The first virtual DLA chip can include a different quantity of DLA cores of the physical DLA chip than the second virtual DLA chip. Determining which computational layers of the first DLA model to execute can further include, at block 573, determining whether results from execution of the second DLA model on results from execution of the first number of computational layers of the first DLA model have a confidence value that is at least a threshold confidence value.

Although not specifically illustrated, the method can include responsive to determining that the results from execution of the second DLA model on the results from execution of the second number of computational layers of the first DLA model have a confidence value that is at least the threshold confidence value, executing the second number of computational layers of the first DLA model, subsequent to the compile time and using the first virtual DLA chip, on data received by the physical DLA chip. The method can include, responsive to determining that the results from execution of the second DLA model on the results from execution of the first number of computational layers of the first DLA model have a confidence value that is less than the threshold confidence value, executing a second number of computational layers of the first DLA model, using the first virtual DLA chip, on the representative data. The second number of computational layers can include an additional computational layer of the first DLA model or exclude a computational layer of the first number of computational layers. The second DLA model can be executed, using the second virtual DLA chip, on results from execution of the second number of computational layers of the first DLA model on the representative data. Whether results from execution of the second DLA model on results from execution of the second number of computational layers of the first DLA model have a confidence value that is at least the threshold confidence value can be determined.

The method can include, responsive to determining that the results from execution of the second DLA model on the results from execution of the second number of computational layers of the first DLA model have a confidence value that is at least the threshold confidence value, executing, subsequent to the compile time and using the first virtual DLA chip, the second number of computational layers of the first DLA model on data received by the physical DLA chip. The method can include, responsive to determining that the results from execution of the second DLA model on the results from execution of the first number of computational layers of the first DLA model have a confidence value that is less than the threshold confidence value, executing a number of computational layers of the second DLA model, using the second virtual DLA chip, on the results from execution of the second number of computational layers of the first DLA model on the representative data. The number of computational layers of the second DLA model can include an additional computational layer of the second DLA model or exclude a computational layer of the second DLA model executed on the results from execution of the first number of computational layers of the first DLA model.

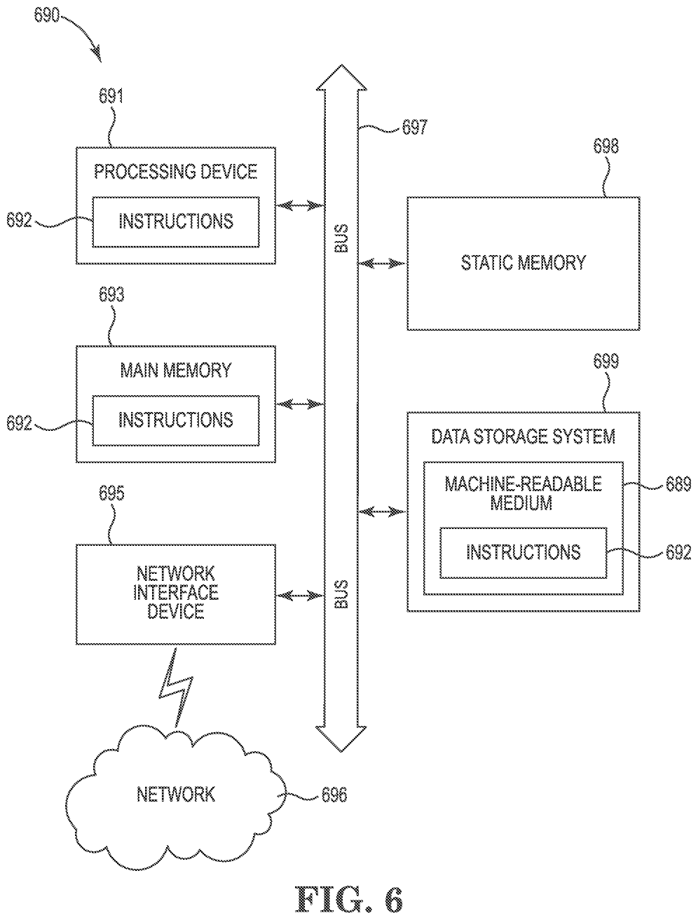

FIG. 6 illustrates an example computer system 690 within which a set of instructions, for causing the machine to perform various methodologies discussed herein, can be executed. In various embodiments, the computer system 690 can correspond to a system (e.g., the computing system 100 described in association with FIG. 1) that includes, is coupled to, or utilizes a memory sub-system (e.g., the memory device 104) or can be used to perform the operations of control circuitry. In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 690 includes a processing device 691, a main memory 693 (e.g., read-only memory (ROM), flash memory, dynamic random access memory (DRAM) such as synchronous DRAM (SDRAM) or Rambus DRAM (RDRAM), etc.), a static memory 697 (e.g., flash memory, static random access memory (SRAM), etc.), and a data storage system 699, which communicate with each other via a bus 697.

The processing device 691 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 691 can also be one or more special-purpose processing devices such as an application specific integrated circuit (ASIC), a field programmable gate array (FPGA), a digital signal processor (DSP), network processor, or the like. The processing device 691 is configured to execute instructions 692 for performing the operations and steps discussed herein. The computer system 690 can further include a network interface device 695 to communicate over the network 696.

The data storage system 699 can include a machine-readable storage medium 689 (also known as a computer-readable medium) on which is stored one or more sets of instructions 692 or software embodying any one or more of the methodologies or functions described herein. The instructions 692 can also reside, completely or at least partially, within the main memory 693 and/or within the processing device 691 during execution thereof by the computer system 690, the main memory 693 and the processing device 691 also constituting machine-readable storage media.

In some embodiments, the instructions 692 include instructions to implement functionality corresponding to the host 102 and/or the memory device 104. The instructions 692 can be executed to cause the machine to assign a first quantity of a plurality of DLA cores of a physical DLA chip to a first virtual DLA chip based on a first processing requirement of a first DLA model and assign a second quantity of the plurality of DLA cores of the physical DLA chip to a second virtual DLA chip based on a second processing requirement of a second DLA model. The instructions 692 can be executed to cause the machine to execute the first DLA model using the first virtual DLA chip and execute the second DLA model using the second virtual DLA chip. The instructions 692 can be executed to cause the machine to assign a greater quantity of the plurality of DLA cores to the first virtual DLA chip than to the second virtual DLA chip in response to the first processing requirement being greater than the second processing requirement. The instructions 692 can be executed to cause the machine to assign a lesser quantity of the plurality of DLA cores to the first virtual DLA chip than to the second virtual DLA chip in response to the second processing requirement being greater than the first processing requirement.

The instructions 692 can be executed to cause the machine to, responsive to instructions to execute a third DLA model, assign a third quantity of the plurality of DLA cores to a third virtual DLA chip based on a third processing requirement of the third DLA model. The third processing requirement can be different than the first and second processing requirements. The instructions 692 can be executed to cause the machine to execute the third DLA model using the third virtual DLA chip. The instructions 692 can be executed to cause the machine to, responsive to subsequent instructions to execute the first DLA model, assign the first quantity of the plurality of DLA cores to the first virtual DLA chip and execute the first DLA model using the first virtual DLA chip having the first quantity of the plurality of DLA cores assigned thereto. The instructions 692 can be executed to cause the machine to, responsive to instructions to execute a fourth DLA model, assign a fourth quantity of the plurality of DLA cores to a fourth virtual DLA chip based on a fourth processing requirement of the fourth DLA model and execute the fourth DLA model using the fourth virtual DLA chip. The fourth processing requirement can be different than the third processing requirement.

The instructions 692 can be executed to cause the machine to determine whether execution of a computational layer of a first DLA model on representative data, using a first virtual DLA chip, yields results having at least a threshold confidence value. A non-limiting example of a confidence value is an accuracy value (e.g., correct inferences per second per watt). The first virtual DLA chip can include a first plurality of DLA cores of a physical DLA chip. The instructions 692 can be executed to cause the machine to, responsive to determining that execution of the computational layer of the first DLA model yields results having less than the threshold confidence value, execute a second DLA model, using a second virtual DLA chip, on results from execution of the number of computational layers of the first DLA model. The second virtual DLA chip can include a second plurality of DLA cores of the physical DLA chip that is greater than the first plurality of DLA cores. The instructions 692 can be executed to cause the machine to, responsive to determining that execution of a respective last computational layer of the first DLA model yields results having less than the threshold confidence value, assign an additional DLA core of the physical DLA chip to the first virtual DLA chip and execute the first DLA model on data received by the physical DLA chip using the first virtual DLA chip including the additional DLA core. The instructions 692 can be executed to cause the machine to determine whether execution of the computational layer of the first DLA model on the representative data yields results having at least the threshold confidence value at a compile time.

The instructions 692 can be executed to cause the machine to determine whether the execution of the second DLA model provides at least a threshold quantity of correct inferences per second per watt. The instructions 692 can be executed to cause the machine to, responsive to determining that execution of the second DLA model yields results having less than the threshold quantity of correct inferences per second per watt, assign another additional DLA core of the physical DLA chip to the second virtual DLA chip and execute the second DLA model on the data received by the physical DLA chip using the second virtual DLA chip including the other additional DLA core.

While the machine-readable storage medium 689 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Although specific embodiments have been illustrated and described herein, those of ordinary skill in the art will appreciate that an arrangement calculated to achieve the same results can be substituted for the specific embodiments shown. This disclosure is intended to cover adaptations or variations of various embodiments of the present disclosure. It is to be understood that the above description has been made in an illustrative fashion, and not a restrictive one. Combinations of the above embodiments, and other embodiments not specifically described herein will be apparent to those of skill in the art upon reviewing the above description. The scope of the various embodiments of the present disclosure includes other applications in which the above structures and methods are used. Therefore, the scope of various embodiments of the present disclosure should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
executing a first deep learning accelerator (DLA) model using a first subset of a plurality of DLA cores of a DLA chip; and
executing a second DLA model using a second subset of the plurality of DLA cores of the DLA chip,
wherein the first subset comprises a first quantity of the plurality of DLA cores and the second subset comprises a second quantity of the plurality of DLA cores that is different than the first quantity of the plurality of DLA cores.

2. The method of claim 1, further comprising assigning the first quantity of the plurality of DLA cores to the first subset of the DLA cores based at least in part on a first computational capability of the first DLA model.

3. The method of claim 2, further comprising assigning the second quantity of the plurality of DLA cores to the second subset of the DLA cores based at least in part on a second computational capability of the second DLA model,
wherein the second computational capability is greater than the first computational capability.

4. The method of claim 3, wherein assigning the second quantity of the plurality of DLA cores comprises assigning a greater quantity of the plurality of DLA cores to the second subset of the plurality of DLA cores than the first quantity of the plurality of DLA cores assigned to the first subset of the plurality of DLA cores.

5. The method of claim 3, further comprising assigning less than all of the plurality of DLA cores to a respective subset of the DLA cores.

6. The method of claim 3, further comprising assigning the first quantity and the second quantity of the plurality of DLA cores without regard to a total quantity of the plurality of DLA cores.

7. The method of claim 1, further comprising executing the first DLA model using the first subset of the plurality of DLA cores and the second DLA model using the second subset of the plurality of DLA cores at least partially concurrently.

8. The method of claim 1, further comprising:
executing a third DLA model using a third subset of the plurality of DLA cores of the DLA chip, wherein the third subset comprises a third quantity of the plurality of DLA cores that is different than the first and third quantities of the plurality of DLA cores; and
assigning the third quantity of the plurality of DLA cores to the third subset of the DLA cores based at least in part on a third computational capability of the third DLA model, wherein the third computational capability is different than the first and second computational capabilities.

9. An apparatus, comprising:
a physical deep learning accelerator (DLA) chip comprising a plurality of DLA cores; and
a compiler coupled to the physical DLA chip and configured to:
assign a number of DLA cores of the physical DLA chip to a virtual DLA chip; and
cause the number of DLA cores to execute a DLA model having a computational capability that is less than a cumulative computational capability of the plurality of DLA cores.

10. The apparatus of claim 9, wherein the compiler is further configured to assign the number of DLA cores to the virtual DLA chip based at least in part on a size of a computational layer of the DLA model.

11. The apparatus of claim 9, wherein the compiler is further configured to:
assign a different number of DLA cores of the physical DLA chip to a different virtual DLA chip, and
cause the different number of DLA cores of the different virtual DLA chip to execute a different DLA model.

12. The apparatus of claim 11, wherein the compiler is further configured to:
assign the number of DLA cores to the virtual DLA chip based at least in part on a size of a computational layer of the DLA model; and
assign the different number of DLA cores to the different virtual DLA chip based at least in part on a size of a computational layer of the different DLA model,
wherein the size of the computational layer of the DLA model is different than the size of the computational layer of the different DLA model.

13. The apparatus of claim 11, wherein the compiler is further configured to:
assign the number of DLA cores to the virtual DLA chip based at least in part on a computational capability of the DLA model; and
assign the different number of DLA cores to the different virtual DLA chip based at least in part on a computational capability of the different DLA model,
wherein the computational capability of the DLA model is different than the computational capability of the different DLA model.

14. The apparatus of claim 11, wherein the compiler is further configured to assign the number of DLA cores to the virtual DLA chip based at least in part on signaling indicative of a user-defined quantity of DLA cores to assign to the virtual DLA chip.

15. The apparatus of claim 11, wherein the compiler is further configured to assign the number of DLA cores to the virtual DLA chip based at least in part on signaling indicative of a user-defined subset of the plurality of DLA cores of the physical DLA chip to assign to the virtual DLA chips.

16. A non-transitory machine-readable medium storing instructions executable by a processing resource to:
assign a first quantity of a plurality of deep learning accelerator (DLA) cores of a physical DLA chip to a first virtual DLA chip based at least in part on a first processing requirement of a first DLA model;
assign a second quantity of the plurality of DLA cores of the physical DLA chip to a second virtual DLA chip based at least in part on a second processing requirement of a second DLA model;
execute the first DLA model using the first virtual DLA chip; and
execute the second DLA model using the second virtual DLA chip.

17. The medium of claim 16, further storing instructions to:
assign a greater quantity of the plurality of DLA cores to the first virtual DLA chip than to the second virtual DLA chip in response to the first processing requirement being greater than the second processing requirement; and
assign a lesser quantity of the plurality of DLA cores to the first virtual DLA chip than to the second virtual DLA chip in response to the second processing requirement being greater than the first processing requirement.

18. The medium of claim 16, further storing instructions to:
responsive to instructions to execute a third DLA model, assign a third quantity of the plurality of DLA cores to a third virtual DLA chip based at least in part on a third processing requirement of the third DLA model, wherein the third processing requirement is different than the first and second processing requirements; and
execute the third DLA model using the third virtual DLA chip.

19. The medium of claim 18, further storing instructions to:
responsive to subsequent instructions to execute the first DLA model, assign the first quantity of the plurality of DLA cores to the first virtual DLA chip; and
execute the first DLA model using the first virtual DLA chip having the first quantity of the plurality of DLA cores assigned thereto.

20. The medium of claim 18, further storing instructions to:
responsive to instructions to execute a fourth DLA model, assign a fourth quantity of the plurality of DLA cores to a fourth virtual DLA chip based at least in part on a fourth processing requirement of the fourth DLA model, wherein the fourth processing requirement is different than the third processing requirement; and
execute the fourth DLA model using the fourth virtual DLA chip.

21. A non-transitory machine-readable medium storing instructions executable by a processing resource to:
determine whether execution of a computational layer of a first deep learning accelerator (DLA) model on representative data, using a first virtual DLA chip, yields results having at least a threshold confidence value,
wherein the first virtual DLA chip comprises a first plurality of DLA cores of a physical DLA chip;
responsive to determining that execution of the computational layer of the first DLA model yields results having less than the threshold confidence value, execute a second DLA model, using a second virtual DLA chip, on results from execution of the computational layer of the first DLA model,
wherein the second virtual DLA chip comprises a second plurality of DLA cores of the physical DLA chip that is greater in quantity than the first plurality of DLA cores; and
responsive to determining that execution of a respective last computational layer of the first DLA model yields results having less than the threshold confidence value:
assign an additional DLA core of the physical DLA chip to the first virtual DLA chip; and
execute the first DLA model on data received by the physical DLA chip using the first virtual DLA chip including the additional DLA core.

22. The medium of claim 21, further storing instructions to determine whether execution of the computational layer of the first DLA model on the representative data yields results having at least the threshold confidence value at a compile time.

23. The medium of claim 21, further storing instructions to:
determine whether the execution of the second DLA model provides at least a threshold quantity of correct inferences per second per watt; and
responsive to determining that execution of the second DLA model yields results having less than the threshold quantity of correct inferences per second per watt:
assign another additional DLA core of the physical DLA chip to the second virtual DLA chip; and
execute the second DLA model on the data received by the physical DLA chip using the second virtual DLA chip including the other additional DLA core.

24. A method, comprising:
determining which computational layers of a first deep learning accelerator (DLA) model to execute on data received by a physical DLA chip subsequent to compile time by:
executing, at the compile time and using a first virtual DLA chip, a first number of computational layers of a first DLA model on representative data;
executing a second DLA model, using the second virtual DLA chip, on results from execution of the first number of computational layers of the first DLA model on the representative data,
wherein the first virtual DLA chip comprises a different quantity of DLA cores of the physical DLA chip than the second virtual DLA chip; and
determining whether results from execution of the second DLA model on results from execution of the first number of computational layers of the first DLA model have a confidence value that is at least a threshold confidence value.

25. The method of claim 24, further comprising, responsive to determining that the results from execution of the second DLA model on the results from execution of the first number of computational layers of the first DLA model have a confidence value that is at least the threshold confidence value:
executing, subsequent to the compile time and using the first virtual DLA chip, the first number of computational layers of the first DLA model on data received by the physical DLA chip; and
executing the second DLA model on results from execution of the first number of computational layers of the first DLA model.

26. The method of claim 25, further comprising, responsive to determining that the results from execution of the second DLA model on the results from execution of the first number of computational layers of the first DLA model have a confidence value that is less than the threshold confidence value:
executing, using the first virtual DLA chip, a second number of computational layers of the first DLA model on the representative data, wherein the second number of computational layers includes an additional computational layer of the first DLA model or excludes a computational layer of the first number of computational layers;
executing, using the second virtual DLA chip, the second DLA model on results from execution of the second number of computational layers of the first DLA model on the representative data; and
determining whether results from execution of the second DLA model on results from execution of the second number of computational layers of the first DLA model have a confidence value that is at least the threshold confidence value.

27. The method of claim 26, further comprising, responsive to determining that the results from execution of the second DLA model on the results from execution of the second number of computational layers of the first DLA model have a confidence value that is at least the threshold confidence value:
executing, using the first virtual DLA chip, the second number of computational layers of the first DLA model on data received by the physical DLA chip subsequent to the compile time.

28. The method of claim 26, further comprising, responsive to determining that the results from execution of the second DLA model on the results from execution of the first number of computational layers of the first DLA model have a confidence value that is less than the threshold confidence value:
executing a number of computational layers of the second DLA model, using the second virtual DLA chip, on the results from execution of the second number of computational layers of the first DLA model on the representative data,
wherein the number of computational layers includes an additional computational layer of the second DLA model or excludes a computational layer of the second DLA model executed on the results from execution of the first number of computational layers of the first DLA model.
